(19) United States
(12) Patent Application Publication
(10) Pub. No.: US 2008/0258990 A1
(43) Pub. Date: Oct. 23, 2008

(54) Parasitically-coupled surface-attachable antenna systems and related methods

(76) Inventors: Dennis A. Burrell, Round Rock, TX (US); Kevin Mundt, Austin, TX (US); Leo Joseph Gerten, Pflugerville, TX (US); Jeff A. Shaw, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/787,584

(22) Filed: Apr. 17, 2007

(51) Int. Cl. H01Q 21/00

(52) U.S. Cl. 343/835

(57) ABSTRACT

Antenna systems and methods are disclosed having parasitically-coupled surface-attachable antenna systems that provide significant advantages for portable information handling systems. A secondary antenna is coupled within a chassis for an information handling system, and a primary antenna is attached to an external surface of the chassis for the portable information handling system. The primary antenna element is configured to be parasitically coupled to the secondary antenna. For receive operations, radio frequency (RF) signals are received by the primary antenna element, and signals are parasitically induced on the secondary antenna. For transmit operations, RF signals are transmitted to the secondary antenna element, and signals are parasitically induced on the primary antenna.

### TECHNICAL FIELD OF THE INVENTION

This invention relates to wireless communications for portable information handling systems and, more particularly, to antenna systems for these wireless communication systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Current portable computers contain antennas for connection to wireless communication systems, including wireless LAN (local area network) communication systems, wireless WAN (wide area network) communication systems and wireless PAN (personal area network) communication systems. As the number of different wireless communication possibilities increase for portable systems, the number of antenna systems needed for these wireless communication systems have also increased. As such, some portable computers can need as many as six or more antennas for these communications.

In portable information handling systems, it is often desirable to place antennas in locations within the chassis so as to generate maximum visibility to the RF signals. In short, it is desirable for the incoming and/or outgoing RF signals not to be blocked by portions of the chassis. Therefore, current antennas are commonly placed within the display assembly and are generally placed in the upper corners of the display assembly. The location of these antennas within the display portion of the chassis causes an increase in the required size of the display enclosure due to interference and space requirements. In addition, these antennas typically require an RF (radio frequency) transparent window to allow the RF signals to enter and exit the chassis or case of the portable system. In a chassis that contains a metal housing, for example, external windows must be cut into the housing to form these windows. The resulting hole is generally covered with a plastic part that is transparent to the RF frequencies for the desired communication system. In addition to the difficulty of forming and covering these windows, the antenna structures must typically be spaced a distance from other metal objects within the chassis and from other antenna systems. In order to accommodate these antenna windows and spacing requirements, typical solutions have increased sizes of portable computer cases and/or reduced sizes of the antennas.

Current display assembly structures for portable notebook computer systems typically have an LCD (liquid crystal display) panel, an air gap between the LCD panel and the antenna radiator, and a plastic cover for the RF window. Examples of current antenna solutions are described, for example, in the following references: U.S. Pat. No. 5,677,698; U.S. Pat. No. 6,778,139, U.S. Pat. No. 7,053,844; U.S. Patent Application Publication No. 2005/0024268; and U.S. Patent Application No. 2006/0061512.

### SUMMARY OF THE INVENTION

Antenna systems and methods are disclosed having parasitically-coupled surface-attachable antenna systems that provide significant advantages for portable information handling systems. A secondary antenna is coupled within a chassis for an information handling system, and a primary antenna is attached to an external surface of the chassis for the portable information handling system. The primary antenna element is configured to be parasitically coupled to the secondary antenna. For receive operations, radio frequency (RF) signals are received by the primary antenna element, and signals are parasitically induced on the secondary antenna. For transmit operations, RF signals are transmitted to the secondary antenna element, and signals are parasitically induced on the primary antenna.

Advantageously, the secondary antenna elements can be standardized, and the primary antenna elements can be tuned to particular communication frequencies and then be selected during manufacturing based upon the communication capabilities desired for the portable information handling system. As such, portable chassis can be manufactured and assembled with the secondary antenna within to the portable chassis. At a later time, depending upon the communication capabilities desired, a primary antenna tuned for those communication capabilities can be selected and attached to the external surface of the portable chassis. In addition, the size of the primary antenna is advantageously not limited by the dimensions between the edge of the LCD (liquid crystal display) screen and the edge of the case, as with typical prior antenna system implementations. Rather, an entire non-conducting surface of the display portion of the case can potentially be used. Still further, multiple parasitically-coupled surface-attachable antenna systems may be used for the same portable information handling system.

As described below, other features and variations can be implemented, if desired, and related systems and methods can be utilized, as well.

### DESCRIPTION OF THE DRAWINGS

It is noted that the appended drawings illustrate only exemplary embodiments of the techniques described herein and are, therefore, not to be considered limiting of its scope, for the invention may admit to other equally effective embodiments.

FIG. 1 is a diagram of a parasitically-coupled surface-attachable antenna system for an information handling system.

FIG. 2 is a diagram of a portable computer with one or more parasitically-coupled surface-attachable antenna systems.

FIG. 3A is a flowchart of a parasitically-coupled surface-attachable antenna system for a portable information handling system used for transmitting signals.

FIG. 3B is a flowchart of a parasitically-coupled surface-attachable antenna system for a portable information handling system used for receiving signals.

### DETAILED DESCRIPTION OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer system, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The techniques described herein provide systems and methods for antenna systems for portable information handling systems that use parasitically-coupled surface-attachable antenna systems that provide significant advantages for portable information handling systems.

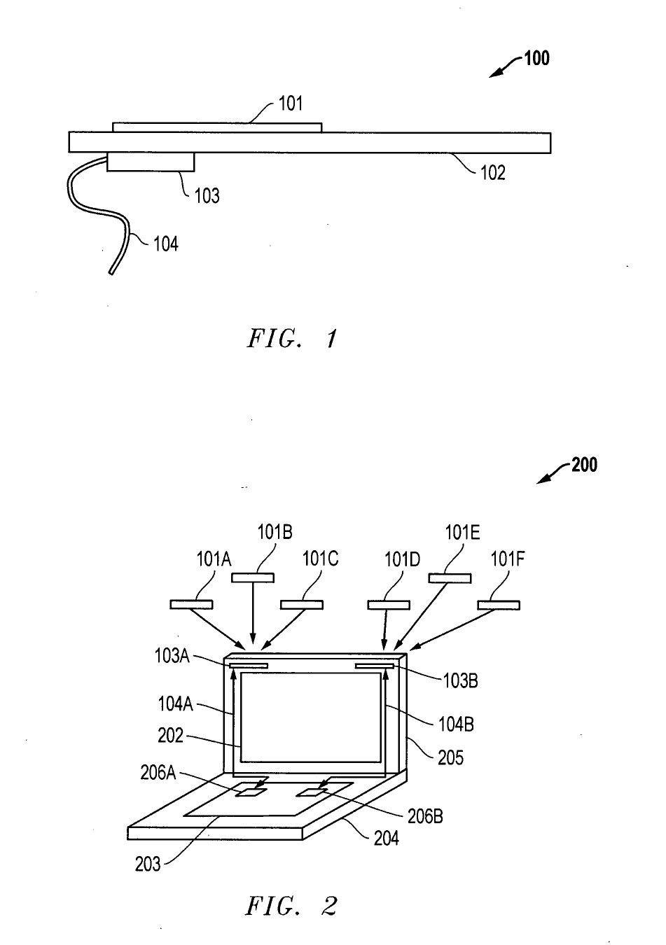

FIG. 1 shows a diagram of a parasitically-coupled surface-attachable antenna system 100 for an information handling system. The view shown in FIG. 1 is looking down along an edge of a case or chassis for an information handling system, for example, an edge of a display chassis portion for a portable notebook computer system. A secondary antenna element 103 is coupled to an inside of a case or chassis 102. A wire or electrical conductor 104 is coupled to the secondary antenna element 103. The electrical conductor 104, such as a coaxial cable, is configured to send or receive electrical signals to or from the secondary antenna element 103. A primary antenna element 101 is coupled to the external surface of the chassis 102 such that, in operation, it is parasitically coupled to the secondary antenna element 103. In this way, radio frequency (RF) signals sent to the secondary antenna element 103 are parasitically induced on the primary antenna element 101, and signals received by the primary antenna element 101 are parasitically induced on the secondary antenna element 103.

As described further below, the primary antenna element 101 can be a label antenna that includes an antenna structure embedded or formed within a flat label. The primary antenna element 101 can also be configured and/or tuned for any desired wireless communication frequencies. These wireless communication frequencies can include, for example, wireless LAN (local area networking) frequencies, wireless WAN (wide area network such as cellular telephone) frequencies, wireless PAN (personal area network such as Bluetooth) frequencies, or any other desired communication frequencies.

It is understood that the secondary antenna element 103 can be a modular antenna structure configured to fit within a predetermined space within the chassis 102. The chassis 102 can be conductive, wherein an RF transmissible aperture is formed within the case through which the secondary antenna element 103 and primary antenna element 101 are parasitically coupled. An RF transparent material can also be used to cover this aperture, if desired. The chassis can also be non-conductive, wherein the primary antenna element 101 is separated from the conductive circuitry within the chassis by this non-conductive material. The non-conductive material can also allow transmission of RF signals so that the secondary antenna element 103 and primary antenna element 101 are parasitically coupled through this RF-transmissible non-conductive material of the chassis 102.

FIG. 2 shows a portable information handling system 200, such as a portable notebook computer system, with one or more parasitically-coupled surface-attachable antenna systems. A portable computer 200 has a bottom chassis portion 204, including an area 203 in which a keyboard, pointing devices and/or other circuitry may be provided. Underneath the keyboard and/or within other portions of the bottom chassis portion 204, additional operational circuitry is also included, such as a microprocessor, related integrated circuits, hard drives, wireless communication cards, memory and/or any other desired circuitry. The portable computer 200 also includes a top chassis portion 205 having an area 202 providing a display, such as a LCD (liquid crystal display) panel. Typically, the top chassis portion 205 is rotatably coupled to the bottom case portion 204, although it could also be coupled in other ways to the bottom chassis portion 204.

As discussed above, the top chassis portion 205 often includes one or more antennas for wireless communications to and from the laptop computer 200. As described herein, one or more of these antennas may be parasitically-coupled surface-attachable antenna systems including a primary antenna element and a secondary antenna element. For this antenna system, the secondary antenna element can be positioned within the chassis for the portable information handling system. And the primary antenna element can be coupled to the external surface of the chassis. For a portable information handling system having a bottom chassis portion including a keyboard and a top chassis portion including display, the primary antenna element is preferably coupled to the back or sides of the top chassis portion. The secondary element is preferably coupled within the top chassis portion so that the primary antenna element and the secondary antenna elements are parasitically coupled. In addition, the top chassis portion can be made from a non-conductive material, such as plastic so that the top chassis portion will provide a radiation barrier between the primary antenna element and metal circuitry within the top chassis portion, including the display circuitry.

Looking back to FIG. 2, a first parasitically-coupled surface-attachable antenna system for the portable computer system 200 includes secondary antenna element 103A which is coupled within the top chassis portion 205, for example, within a predetermined space separate from the display 202. An electrical conductor 104A is coupled to the secondary antenna element 103A and to a communication module 206A that can be located within the bottom chassis portion 204, for example, underneath the keyboard area 203. The communication module 206A is configured to send and/or receive electrical signals to and/or from the secondary antenna element 103A through the electrical conductor 104A. A primary antenna element is coupled to the external surface of the case 102 and is configured to be parasitically coupled to the secondary antenna element 103A. As such, RF signals sent to the secondary antenna element 103A are parasitically induced on the primary antenna element, and signals received by the primary antenna element are parasitically induced on the secondary antenna element 103. Thus, the parasitically-coupled surface-attachable antenna system can be used for transmit operations, receive operations, or both. As discussed above, the primary antenna element can be selected during manufacture depending upon the communication capabilities desired for the portable computer system 200. As depicted, one of the primary antenna elements 101A, 101B or 101C is selected for secondary antenna element 103A.

A second parasitically-coupled surface-attachable antenna system for portable computer system 200 similarly includes secondary antenna element 103B, a second communication module 206B, a second conductor 104B, and a second primary antenna element. Again, the second primary antenna element can be selected during manufacture depending upon the communication capabilities desired for the portable computer system 200. As depicted, one of the primary antenna elements 101D, 101E or 101F is selected for secondary antenna element 103B.

The parasitically-coupled surface-attachable antenna system formed by the combination of a secondary antenna element 103A or 103B and a primary antenna element 101A, 101B, 101C, 101D, 101E or 101F provides significant advantages over prior solutions. These advantages derive in part from attaching the primary antenna element to the external surface of the chassis for the computer system 200. In contrast with prior solutions where antenna elements do not overlap the display area 202, the primary antenna elements 101A, 101B, 101C, 101D, 101E and/or 101F can extend over portions of the display area 202 because the case 205 can be used to provide an effective signal barrier between the circuitry within the chassis (e.g., LCD circuitry) and the primary antenna elements. In addition, as described herein, the primary antenna element may be made larger due to the reduction in space constraints allowed by using the external surface of the case. This increased size allows for improved performance and a wider range of frequencies with respect to which the primary antenna element can be tuned. In addition, the secondary antenna element can be made smaller because it is not the primary antenna element for purposes of being tuned for the particular signal frequencies used for wireless communications. By allowing the secondary antenna, which is within the case, to be smaller and the primary antenna, which is outside the case, to be the tuned antenna element, a wide variety and combinations of wireless communication frequencies and antenna systems can be provided while still reducing the size needed for the portable information handling system.

The primary antenna elements 101A, 101B, 101C, 101D, 101E and/or 101F can be constructed as desired depending upon the application, geometries and aesthetics desired. In particular, the primary antenna elements can also be shaped, sized and constructed to efficiently receive and/or transmit signals in particular frequency ranges. The primary antenna elements, for example, can be configured for wireless local area networking frequencies, for wireless personal area networking frequencies, for wireless wide area networking frequencies (e.g., cellular telephone frequencies), or for any other desired frequency or set of frequencies.

The disclosed antenna systems are particularly useful for portable information handling systems that utilize plastic, or some other non-conductive material, as an external surface for the chassis for the portable information handling system, such as the chassis for portable notebook computer system. In such a system, the primary antenna radiator element can be placed on the plastic external surface of the notebook computer. Because the plastic enclosure creates a natural barrier from internal metal components, the gaps typically required from those components can be reduced or eliminated.

In one implementation, primary antenna elements can be constructed as antenna structures embedded or formed within a label that can be attached to the back or side surfaces of an information handling system. An antenna label could use antenna structures such as those currently utilized in RFID (radio frequency identification) labels. RFID labels were developed for identification of products and boxes in inventory systems. An RFID tag is typically formed as a label with an imbedded antenna structure and a microchip to drive the antenna. A label similar to such an RFID label can be utilized that contains a primary antenna radiator element that is of a structure configured and tuned for desired communication frequencies, such as wireless LAN, wireless PAN or wireless WAN frequency configurations. This label antenna is then adhered to an external surface of the chassis for the information handling system, such as an external surface for a plastic chassis for a portable notebook computer system. This label antenna can then be driven by a smaller coupling aperture secondary antenna element within the chassis or case for the information handling system.

As indicated above antenna radiator elements are typically sized based upon desired communication frequencies. In particular, antenna radiator elements are typically sized based on fractional divisions of the wavelengths of the desired operational frequencies. An antenna element that is sized in a one-to-one correspondence with the wavelength of the frequency will usually provide the best antenna performance. However, this optimal sizing typically causes the antenna to be significantly larger than can be accommodated within a portable notebook computer system. The antennas that are currently used in many notebook computers are about 80-90 mm in length. This sizing allows for an antenna element that is ¼ of the typical wireless WAN wavelength (e.g., cellular telephone wavelengths). The use of a primary radiator element on an external surface of the chassis or case, such as an RFID-label type primary element, allows for a longer radiator antenna element that would otherwise be allowable based upon size and interference constraints within the chassis itself. Using the label antenna or some other antenna implementation coupled to the outside of the chassis, therefore, allows for longer and more efficient antenna elements to be utilized. For example, a primary antenna radiator element that is ½ of the cellular band wavelength can be achieved using such an externally coupled configuration. The coupling aperture secondary antenna element can then be implemented as a relatively small antenna in order to take up minimal space within the chassis. This secondary antenna element is then placed within the proximity of, but not physically coupled to, the primary antenna element such that signals on the secondary antenna element parasitically couple to the larger primary antenna element, and signals on the primary antenna element parasitically couple to the smaller secondary antenna element. Further, with respect to label antennas, label antennas are easier to tune in product development than sheet metal antenna structures typically used within a chassis.

Advantages of the parasitically-coupled surface-attachable antenna system include allowing for reduced size antenna elements internal to chassis and allowing for longer length primary radiator elements for better antenna performance. In addition, as an external element, the primary antenna element is naturally spaced from internal metal components. Further, the coupling aperture secondary antenna element does not require tuning for each chassis because it is the primary antenna element that is tuned for the desired communication frequencies. As such, antenna usage can be configured for each system in the factory by utilizing different primary antenna elements, such as different label antennas. In this way, if the system is populated with a wireless WAN card (e.g., cellular telephone card), the primary radiator label antenna element selected for the system could be tuned for the selected wireless WAN frequencies. Alternatively, if a DVB-H (digital video television broadcasts) card was populated in the system, then a primary radiator label antenna element that is tuned for the DVB-H frequencies could be installed. In addition, a plurality of parasitically-coupled surface-attachable antenna systems could be utilized with respect to the same information handling system, if desired. It is further noted that the primary antenna elements and/or the secondary antenna elements can be different constructions, if desired. In addition, parasitically-coupled surface-attachable antenna systems can be used with other types of antenna systems within the same information handling system.

As shown in FIG. 2, the portable information handling system can comprise more than one secondary antenna element and more than one primary antenna element. FIG. 2 shows two secondary antenna elements 103A and 103B, each of which can be selectably configured in an antenna system with a plurality of primary antenna elements. As depicted, one of three primary antenna elements 101A, 101B and 101C is selected for secondary antenna element 103A, and one of three primary antenna elements 101D, 101E and 101F is selected for secondary antenna element 103B. It is noted that any number of combinations can be used, including a one-to-one correspondence between secondary and primary antennas, while still taking advantage of parasitically-coupled surface-attachable antenna systems as described herein. As described herein, the primary antenna elements are parasitically coupled to the secondary antenna elements so that the primary antenna elements are freed at least in part from the space constraints caused by embedding the antenna structures within the chassis. It is also again noted that the portable information handling system can include one or more additional antenna systems that do not use parasitically coupled antenna elements.

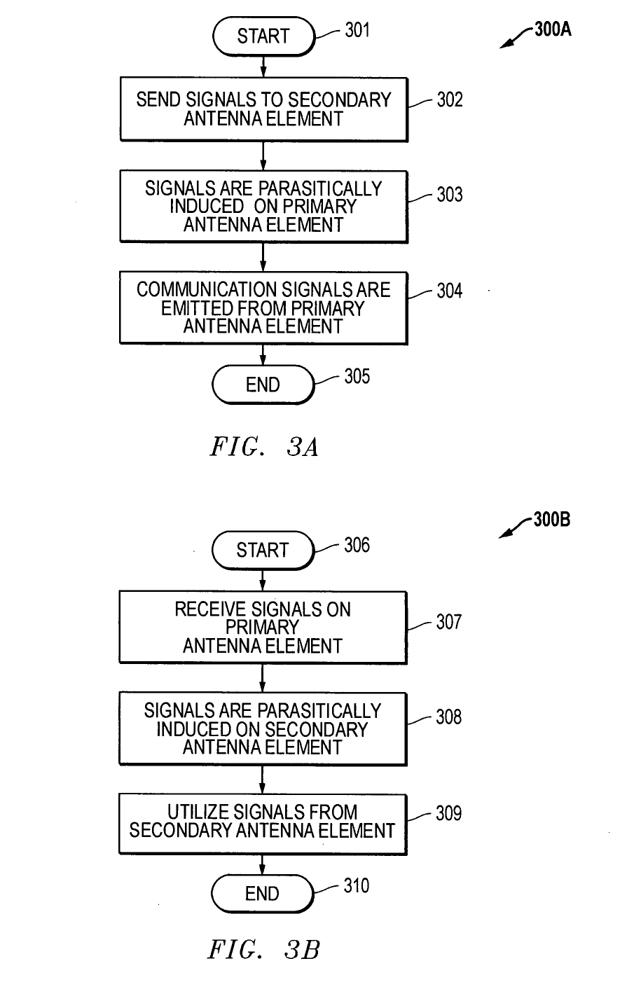

FIG. 3A shows a flowchart 300A of the wireless communications in a portable information handling system wherein signals are transmitted. The process starts in step 301. In step 302, signals are sent to a secondary antenna element coupled within a case for a portable information handling system. In step 303, the signals applied to the secondary antenna element parasitically induce signals on a primary antenna element coupled to an outer side of the case for the portable information handling system. In step 304, communication signals in the form of RF radiation are emitted from the primary antenna element. Then the process ends in step 305.

FIG. 3B shows a flowchart 300B of the wireless communications in a portable information handling system wherein signals are received. The process starts in step 306. In step 307, signals are received on a primary antenna element coupled to an outer side of a case for a portable information handling system. In step 308, the signals received by the primary antenna element parasitically induce signals on a secondary antenna element coupled within the case for the portable information handling system. In step 309, the induced signals from the secondary antenna element are processed and utilized within the portable information handling system. The process ends in step 310.

The transmit and receive processes described in FIGS. 3A and 3B can further include using additional antenna systems within the portable information handling system. For example, a second secondary antenna element and a second primary antenna element can be used to communicate in different frequency ranges from the first primary/secondary antenna elements. In short, a wide variety of configurations can be implemented using the parasitically-coupled surface-attachable antenna systems described herein.

Further modifications and alternative embodiments of the techniques described herein will be apparent to those skilled in the art in view of this description. It will be recognized, therefore, that the techniques described herein are not limited by these example arrangements. Accordingly, this description is to be construed as illustrative only and is for the purpose of teaching those skilled in the art the manner of carrying out the techniques described herein. It is to be understood that the forms of the techniques described herein shown and described are to be taken as the presently preferred embodiments. Various changes may be made in the implementations and architectures. For example, equivalent elements may be substituted for those illustrated and described herein and certain features of the techniques described herein may be utilized independently of the use of other features, all as would be apparent to one skilled in the art after having the benefit of this description of the techniques.

What is claimed is:

1. A portable information handling system having a parasitically coupled antenna system, comprising:
a bottom chassis portion for a portable information handling system including a keyboard;
a top chassis portion for a portable information handling system including a display, the top case portion being coupled to the bottom case portion;
a secondary antenna element coupled within the top chassis portion;
an electrical conductor coupled to the secondary antenna element and configured to send or receive electrical signals to or from the secondary antenna element;
a communication module located within the bottom case portion, coupled to the electrical conductor, and configured to send or receive electrical signals to the secondary antenna element through the electrical conductor;
a primary antenna element coupled to an external surface of the top chassis portion and configured to be parasitically coupled to the secondary antenna element; and
a non-conductive material positioned between the primary antenna element and metal components within the chassis.

2. The antenna system of claim 1, wherein the non-conductive material comprises a non-conductive external surface of the chassis to which the primary antenna element is coupled.

3. The antenna system of claim 2, wherein the non-conductive external surface is plastic.

4. The portable information handling system of claim 1, wherein the primary antenna element extends over a portion of the display.

5. The portable information handling system of claim 4, wherein the secondary antenna element does not extend over any portion of the display.

6. The portable information handling system of claim 1, wherein the primary antenna element comprises a label antenna.

7. The portable information handling system of claim 1, wherein the primary antenna element is configured for wireless local area networking frequencies.

8. The portable information handling system of claim 1, wherein the primary antenna element is configured for cellular telephone frequencies.

9. The portable information handling system of claim 1, further comprising a second secondary antenna element coupled within the top chassis portion and a second primary antenna element coupled to an external surface of the top chassis portion and configured to be parasitically coupled to the second secondary antenna element.

10. The portable information handling system of claim 9, further comprising a second communication module and a second electrical conductor coupled to the second secondary antenna element.

11. The portable information handling system of claim 1, further comprising at least one additional antenna system that does not use parasitically coupled antenna elements.

12. The portable information handling system of claim 1, wherein the electrical conductor comprises a coaxial cable.

13. The portable information handling system of claim 1, wherein the secondary antenna element comprises an antenna structure configured to fit within a predetermined space within the chassis.

14. An antenna system for an information handling system, comprising:
a secondary antenna element coupled within a chassis for an information handling system;
an electrical conductor coupled to the secondary antenna and configured to send or receive electrical signals to or from the secondary antenna element; and
a primary antenna element coupled to an external surface of the chassis and configured to be parasitically coupled to the secondary antenna element.

15. The antenna system of claim 14, wherein the primary antenna element comprises a label antenna.

16. The antenna system of claim 14, wherein the primary antenna element is configured for a selected communication frequency range.

17. A method for wireless communications in a portable information handling system, comprising:
sending signals to a secondary antenna element coupled within a chassis for a portable information handling system to parasitically induce signals on a primary antenna element coupled to an external surface of the chassis; or
receiving signals on a primary antenna element coupled to an external surface of a chassis for a portable information handling system to parasitically induce signals on a secondary antenna element coupled within the chassis.

18. The method of claim 17, further comprising utilizing a label antenna as the primary antenna element.

19. The method of claim 17, wherein the sending and receiving steps are both performed for bidirectional wireless communications.

20. The method of claim 19, wherein the sending and receiving steps comprise sending and receiving signals in a selected communication frequency range.
